(19) United States
(12) Patent Application Publication
(10) Pub. No.: US 2006/0124781 A1
(43) Pub. Date: Jun. 15, 2006

(54) Method and apparatus for dispensing coating materials

(76) Inventor: Ghaffar Kazkaz, Rolling Meadow, IL (US)

Correspondence Address: BARNES & THORNBURG, 11 South Meridian Street, Indianapolis, IN, 46204, US

(21) Appl. No.: 11/328,320

(22) Filed: Jan. 9, 2006

Related U.S. Application Data
(63) Continuation of application No. 10/097,493, filed on Mar. 14, 2002.

(51) Int. Cl. B05B 5/025; B05C 5/00; B05B 7/00

(52) U.S. Cl. 239/694; 118/620; 118/629; 118/300

(57) ABSTRACT

Disposable containers are provided for containing different types, for example, different colors, of coating material to be dispensed onto one or more articles. A method of coating articles includes providing a dispensing device for dispensing coating onto the articles. A high-magnitude potential supply is selectively coupled to the dispensing device for supplying electrostatic charge to the coating as the coating is being dispensed. A first disposable container containing a first coating material to be dispensed onto a first one of the articles is coupled to the dispensing device as the first article is presented for coating, and the first coating material is dispensed onto the first article. A second disposable container is filled with a second coating material to be dispensed onto a second one of the articles, for example, while the first coating material is being dispensed onto the first article. Upon completing coating of the first article with the first coating material, the supply of high-magnitude potential to the dispensing device is interrupted, and the first container is uncoupled from the dispensing device. The first coating material is flushed from the dispensing device. The second container containing the second coating material is coupled to the dispensing device, and the supply of high-magnitude potential to the dispensing device is resumed as the second article is presented for coating.

### FIELD OF THE INVENTION

This invention relates to improvements in so-called “voltage blocks.” Voltage blocks are devices for the isolation of components of a system which are maintained at high-magnitude electrical potential from typically grounded system components, even in the presence of continuous or intermittent flow of, for example, an electrically non-insulative fluid therebetween. The invention is disclosed in the context of a system for atomizing and dispensing electrically charged particles of coating materials, such as water-based coating materials, that are bulk electrical non-insulators. However, it is believed to be useful in other contexts as well.

### BACKGROUND OF THE INVENTION

Voltage blocks generally function to minimize, to the extent they can, the flow of current. Such current would otherwise flow from first system components maintained at high-magnitude electrical potential through a stream of electrically non-insulative fluid, such as, for example, water-base coating material, flowing between the first components and second system components maintained at a much lower-magnitude electrical potential or ground potential.

As used herein, the term “electrically non-conductive” means electrically more insulative than the term “electrically conductive.” The term “electrically non-insulative” means electrically more conductive than the term “electrically insulative.”

Several types of voltage blocks are known. There are, for example, the devices illustrated and described in U.S. Pat. Nos. 4,878,622; 4,982,903; 5,033,942; 5,154,357; and 5,193,750, and the references cited in those patents, particularly including U.S. Pat. Nos. 1,655,262; 2,547,440; 2,673,232; 3,098,890; 3,122,320; 3,291,889; 3,893,620; 3,933,285; 3,934,055; 4,017,029; 4,020,866; 4,085,892; 4,275,834; 4,313,475; 4,383,644; and, 4,413,788, and U.K. Patent Specifications 1,393,333 and 1,478,853. Also of interest are U.S. Pat. Nos. 2,814,551; 2,816,822; 2,921,604; 3,121,024; 3,145,930; 3,219,327; 3,373,762; 3,419,827; 3,450,092; 3,458,133; 3,674,205; 3,735,669; 3,838,946; 4,030,860; 4,232,055; 4,285,446; 4,304,252; 4,304,529; 4,381,180; 4,386,888; 4,481,557; 4,491,055; 4,515,516; 4,552,334; 4,637,783; 4,680,930; 4,741,673; 4,792,092; 4,879,137; 4,881,688; 4,884,745; 4,932,589; 4,962,724; 5,058,812; 5,078,168; 5,094,389; 5,096,126; 5,102,045; 5,102,046; 5,105,851; 5,197,676; 5,244,012; 5,249,748; 5,255,856; 5,273,072; 5,288,029; 5,288,525; 5,326,031; 5,340,289; 5,341,990; and, 5,364,035; and Russian patent specification 1,562,546. No representation is intended by this listing that this is a complete listing of all pertinent prior art, or that a thorough search of all pertinent prior art has been conducted, or that no better prior art exists. Nor should any such representation be inferred.

As the above listing demonstrates, devices and methods for dispensing electrically charged, electrically non-insulative materials are the subject of considerable interest in, for example, the coating industry. However, existing technologies still present large numbers of parts to clean when changing the type, for example, the color, of coating material being dispensed. This results in relatively longer cleaning cycles during which articles are not being coated. It also results in greater volumes of waste cleaning solvent(s), which must be treated in an environmentally responsible manner. The present invention is intended to address these problems, providing: simplicity; fewer components to clean when changing the type of coating material which is to be dispensed; reduced volumes of waste cleaning solvent(s); and shorter coating material change cycles.

### DISCLOSURE OF THE INVENTION

According to one aspect of the invention, a disposable container is provided for containing a coating material to be dispensed onto one or more articles.

Illustratively according to this aspect of the invention, the disposable container includes a coupler for removably coupling the disposable container to a coating dispensing apparatus.

Further illustratively according to this aspect of the invention, the disposable container includes a disposable resin or polymer bag.

According to another aspect of the invention, apparatus for coating articles includes means for dispensing coating material onto the articles, means for supplying electrical charge to the coating material as it is being dispensed, and means for coupling the electrical charge supply means to the means for dispensing coating material. Also provided are first means for containing a first coating material to be dispensed onto a first one of the articles as the first article is presented for coating, means for coupling the first means for containing a first coating material to the means for dispensing coating material, means for filling a second means for containing a second coating material with the second coating material to be dispensed onto a second one of the articles, means for flushing the first coating material from the dispensing device, and means for coupling the second means for containing a second coating material to the dispensing device. The means for coupling the electrical charge supply means to the means for dispensing coating material interrupts the supply of electrical charge to the dispensing device after coating the first article with the first coating material and resumes the supply of electrical charge to the dispensing device as the second article is presented for coating.

Illustratively according to this aspect of the invention, the first or second means for containing a first or second coating material, respectively, includes a disposable first or second means for containing a first or second coating material, respectively.

Further illustratively according to this aspect of the invention, the first or second means for containing a first or second coating material, respectively, includes a disposable first or second resin or polymer bag, respectively.

Additionally illustratively according to this aspect of the invention, the means for coupling the electrical charge supply means to the means for dispensing coating material includes a switch.

According to another aspect of the invention, apparatus for coating articles includes a dispensing device for dispensing coating onto the articles, means for controlling the supply of electrical charge to the dispensing device, the control means supplying electrical charge to the coating as it is being dispensed, a first container for coupling to the dispensing device, and a second container for coupling to the dispensing device. The first container contains a first coating material to be dispensed onto a first one of the articles, and the second container contains a second coating material to be dispensed onto a second one of the articles. The control means interrupts the supply of electrical charge to the dispensing device and the first container is uncoupled from the dispensing device upon completing coating of the first article with the first coating material. Means are provided for flushing the first coating material from the dispensing device. The second container is coupled to the dispensing device and the control means resumes the supply of electrical charge to the dispensing device as the second article is presented for coating.

Illustratively according to this aspect of the invention, the first or second container includes a disposable first or second container, respectively.

Further illustratively according to this aspect of the invention, the disposable first or second container includes a disposable first or second resin or polymer bag, respectively.

Additionally illustratively according to this aspect of the invention, the means for controlling the supply of electrical charge to the dispensing device includes a switch. Interrupting the supply of electrical charge to the dispensing device includes opening the switch. Resuming the supply of electrical charge to the dispensing device includes closing the switch.

According to another aspect of the invention, apparatus for coating includes at least one means for containing each different type of coating material that is to be dispensed from a coating material dispenser, means for dispensing the different types of coating material, and means for coupling a source of each different type of coating material through a respective valve means to the means for dispensing the different types of coating material. The means for dispensing the different types of coating material includes means for sequentially coupling the means for dispensing the different types of coating material to the at least one means for containing each different type of coating material and actuating the respective valve means to introduce into the at least one means for containing each different type of coating material a respective type of coating material.

Illustratively according to this aspect of the invention, means are provided for coupling a means for containing a respective type of coating material to the means for dispensing the different types of coating material when it is desired to coat an article with the respective type of coating material contained in that means for containing that respective type of coating material to supply that respective type of coating material to the means for dispensing the different types of coating material.

Further illustratively according to this aspect of the invention, means are provided for supplying electrical charge to the coating material as it is being dispensed, and for coupling the electrical charge supply means to the means for dispensing coating material.

Additionally illustratively according to this aspect of the invention, the at least one means for containing each different type of coating material that is to be dispensed includes at least one disposable means for containing each different type of coating material that is to be dispensed.

According to another aspect of the invention, a method of coating articles includes providing a dispensing device for dispensing coating onto the articles, coupling a supply of electrical charge to the coating as it is being dispensed, coupling to the dispensing device a first container containing a first coating material to be dispensed onto a first one of the articles as the first article is presented for coating, and dispensing the first coating material onto the first article. The method further includes filling a second container with a second coating material to be dispensed onto a second one of the articles, completing coating of the first article with the first coating material, interrupting the supply of electrical charge to the dispensing device, uncoupling the first container from the dispensing device, flushing the first coating material from the dispensing device, coupling the second container containing the second coating material to the dispensing device, and resuming the supply of electrical charge to the dispensing device as the second article is presented for coating.

Illustratively according to this aspect of the invention, coupling a first or second container to the dispensing device includes coupling a disposable first or second container, respectively, to the dispensing device.

Further illustratively according to this aspect of the invention, coupling a first or second container to the dispensing device includes coupling a disposable first or second resin or polymer bag, respectively, to the dispensing device.

Additionally illustratively according to this aspect of the invention, coupling the supply of electrical charge to the dispensing device includes coupling the supply of electrical charge through a switch to the dispensing device, interrupting the supply of electrical charge to the dispensing device includes opening the switch, and resuming the supply of electrical charge to the dispensing device includes closing the switch.

According to another aspect of the invention, a method of coating includes providing at least one container for each different type of coating material that is to be dispensed from a coating material dispenser, providing a manifold for dispensing the different types of coating material, coupling a source of each different type of coating material through a respective valve to an inlet to the manifold, sequentially coupling the at least one container for each different type of coating material to an outlet of the manifold, and actuating the respective valves to introduce into the at least one container for each different type of coating material a respective type of coating material.

Illustratively according to this aspect of the invention, the method further includes coupling a container containing a respective type of coating material to the dispenser for dispensing the coating when it is desired to coat an article with the respective type of coating material contained in that container in order to supply that respective type of coating material to the dispenser, dispensing that respective type of coating material and passing an article to be coated with the respective type of coating material through the dispensed coating material.

Further illustratively according to this aspect of the invention, the method includes coupling electrical charge to the dispenser after the container containing a respective type of coating material is coupled to the dispenser and before the article to be coated with the respective type of coating material is passed through the dispensed coating material in order to charge the dispensed coating material.

Additionally illustratively according to this aspect of the invention, providing at least one container for each different type of coating material that is to be dispensed from the coating material dispenser includes providing at least one disposable container for each different type of coating material that is to be dispensed from the coating material dispenser.

### BRIEF DESCRIPTION OF THE DRAWINGS

The invention may best be understood by referring to the following detailed description and accompanying FIGURE which illustrates the invention. The FIGURE is a highly diagrammatic side elevational view of a system according to the invention.

### DETAILED DESCRIPTIONS OF ILLUSTRATIVE EMBODIMENTS

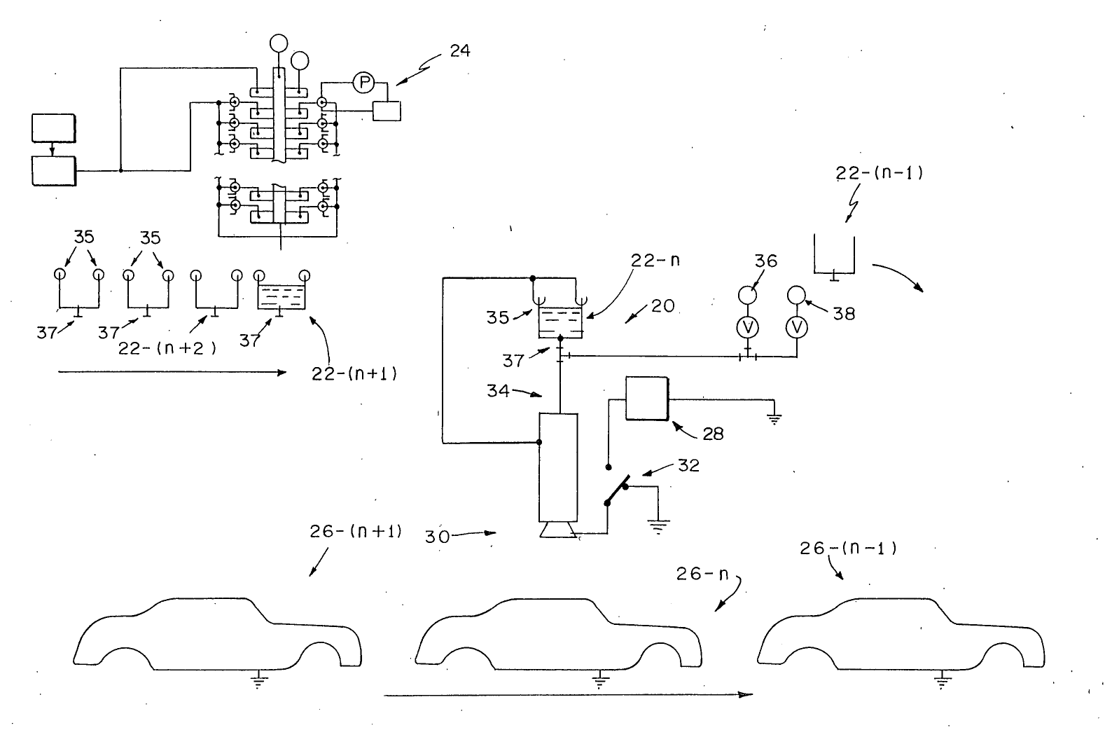

Referring now to FIG. 1, an automated system for filling containers is illustrated. The containers are made of (a) material(s) which are relatively non-reactive with the coating material(s) that will be placed in them and for the amount of time that the coating material(s) will remain in them. For example, where the coating materials are water-base coating materials, leak-resistant resin or polymer bags are suitable. The containers are filled with electrically non-insulative coating materials, such as, for example, water-base paints, from a color manifold. The coating material contained in the containers is then transferred to (a) coating material dispensing device(s) for electrostatically charging and dispensing onto articles such as, for example, automobiles being conveyed past the dispensing device(s) on a conveyor.

In a coating material dispensing system 20 constructed according to the invention, a container 22-n is filled with a coating material, for example, the color with which the next automobile 26-n being conveyed past the coating material dispensing system 20 is scheduled to be coated. The container 22-n is filled from, for example, a color manifold 24 of the type illustrated in U.S. Pat. Nos. 4,159,806; 4,311,724; 4,348,425; 4,350,720; 4,356,868; 4,403,736; 4,592,305; 5,058,812; 5,318,065; 5,632,816; 5,725,150; and, Re. 32,151, and references cited in these U.S. Patents. No representation is intended by this listing that a complete search of all the relevant prior art has been conducted, or that no better art than that listed is available, or that the listed art is relevant. Nor should any such representation be inferred. The filling of the container 22-n is performed, for example, while coating material of a previously selected color is being dispensed onto the automobile 26-(n−1) which was scheduled to be coated by that color.

The coating material dispensing system 20 includes a high-magnitude voltage supply 28 which supplies the high-magnitude electrostatic potential for charging the particles of coating material as they are being dispensed from the coating material dispensing device(s) 30 toward the automobiles . . . 26-(n−1), 26-n, 26-(n+1), . . . which are being conveyed sequentially past the dispensing device(s) 30. When the coating of that previous automobile 26-(n−1) is completed, the high-magnitude voltage supply 28 is disabled, for example, by turning the supply 28 off, by uncoupling 32 the supply 28 from the dispensing device(s) 30, or whatever other means are appropriate under the circumstances.

The last container 22-(n−1) of coating material used on the immediately preceding automobile 26-(n−1) is removed from the fluid circuit 34 to the dispensing device(s) 30 and disposed of in an appropriate manner. A valve is opened and the fluid circuit 34 is flushed with solvent(s) from (a) source(s) 36 to remove traces of the coating material which was previously being dispensed from the fluid circuit 34, and the solvent is dried from the circuit 34 by opening a valve to a source 38 of, for example, compressed air. This reduces the likelihood of cross-contamination of the fluid circuit 34 and dispensing device(s) 30, and thus the next automobile 26-n to be coated, with the immediately preceding coating material. This portion of the cycle may take, for example, two to four seconds.

The container 22-n of the next coating material to be dispensed onto the automobile 26-n scheduled to be coated by that coating material is then coupled into the fluid circuit 34 with the dispensing device(s) 30. In order to facilitate uncoupling container 22-(n−1) from circuit 34 and coupling container 22-n into the circuit 34, containers 22 and circuit 34 can be provided with fluid couplers 37 of any suitable type, such as, for example, quick disconnect fluid couplers. Then, dispensing of coating material from container 22-n onto the automobile 26-n scheduled to be coated by it begins. As it does, the next container 22-(n+1) in the queue is brought into position to begin filling container 22-(n+1) with either the coating material which is currently being dispensed, where the automobile 26-n currently being coated will require more than one container of coating material to complete, or the next coating material which is scheduled to be dispensed onto the next automobile 26-(n+1) which will be conveyed past the dispensing device(s) 30.

As is illustrated, containers 22 can be provided with means, such as eyelets 35 to facilitate handling and dispensing of the coating materials contained in them. Also, although the containers 22 are illustrated as being suspended above the dispensing device(s) 30 on (a) support(s) provided on the dispensing device(s) 30 for feeding coating material from the containers 22 to the dispensing device(s) 30, it should be understood that the circuit 34 could be provided with (a) pump(s) for pumping coating materials from the containers 22 to the device(s) 30. Also as illustrated, the coating material dispensing device(s) 30 and the containers 22 are supported on (an) electrically non-conductive support(s) to isolate the dispensing device(s) 30 and containers 22 from ground as much as possible while they are electrically coupled, 32, to the high-magnitude potential supply 28. To this same end, the conduits for coupling the sources 36 and 38 in the circuit 34 are electrically non-conductive to promote isolation of device(s) 30 and containers 22 when supply 28 is coupled to dispenser(s) 30. When no coating operation is in progress, for example, during flushing of a color from the circuit 34, the coating material dispensing device(s) 30 can be coupled to ground potential through another terminal of the switch 32.

1-37. (canceled)

38. Apparatus for coating articles, the apparatus including a dispensing device for dispensing coating onto the articles, means for controlling the supply of electrical charge to the dispensing device, a disposable first resin or polymer bag for coupling to the dispensing device, the disposable first resin or polymer bag containing a first coating material to be dispensed onto a first one of the articles, a disposable second resin or polymer bag for coupling to the dispensing device, the disposable second resin or polymer bag containing a second coating material to be dispensed onto a second one of the articles, means for flushing the first coating material from the dispensing device, the means for controlling the supply of electrical charge supplying electrical charge to the coating as it is being dispensed, the means for controlling the supply of electrical charge interrupting the supply of electrical charge to the dispensing device and the disposable first resin or polymer bag being uncoupled from the dispensing device upon completing coating of the first article with the first coating material, the disposable second resin or polymer bag containing the second coating material being coupled to the dispensing device and the means for controlling the supply of electrical charge resuming the supply of electrical charge to the dispensing device as the second article is presented for coating.

39. The apparatus of claim 38 wherein the means for controlling the supply of electrical charge to the dispensing device includes a switch, interrupting the supply of electrical charge to the dispensing device including opening the switch, and resuming the supply of electrical charge to the dispensing device including closing the switch.

40. Apparatus for coating articles, the apparatus including means for dispensing coating material onto the articles, means for supplying electrical charge to the coating material as it is being dispensed, means for coupling the electrical charge supply means to the means for dispensing coating material, a disposable first resin or polymer bag for containing a first coating material to be dispensed onto a first one of the articles as the first article is presented for coating, means for coupling the disposable first resin or polymer bag containing a first coating material to the means for dispensing coating material, means for filling a disposable second resin or polymer bag with a second coating material to be dispensed onto a second one of the articles, means for flushing the first coating material from the dispensing device, and means for coupling the disposable second resin or polymer bag containing the second coating material to the dispensing device, the means for coupling the electrical charge supply means to the means for dispensing coating material interrupting the supply of electrical charge to the dispensing device after coating the first article with the first coating material and resuming the supply of electrical charge to the dispensing device as the second article is presented for coating.

41. The apparatus of claim 40 wherein the means for coupling the electrical charge supply means to the means for dispensing coating material includes a switch.

42. Apparatus for coating articles, the apparatus including a dispensing device for dispensing coating onto the articles, means for controlling the supply of electrical charge to the dispensing device, a first reservoir for containing a first coating material to be dispensed onto a first one of the articles, the first reservoir consisting essentially of a disposable first resin or polymer bag for coupling to the dispensing device, a second reservoir for containing a second coating material to be dispensed onto a second one of the articles, the second reservoir consisting essentially of a disposable second resin or polymer bag for coupling to the dispensing device, means for flushing the first coating material from the dispensing device, the means for controlling the supply of electrical charge supplying electrical charge to the coating as it is being dispensed, the means for controlling the supply of electrical charge interrupting the supply of electrical charge to the dispensing device and the disposable first resin or polymer bag being uncoupled from the dispensing device upon completing coating of the first article with the first coating material, the disposable second resin or polymer bag containing the second coating material being coupled to the dispensing device and the means for controlling the supply of electrical charge resuming the supply of electrical charge to the dispensing device as the second article is presented for coating.

43. The apparatus of claim 42 wherein the means for controlling the supply of electrical charge to the dispensing device includes a switch, interrupting the supply of electrical charge to the dispensing device including opening the switch, and resuming the supply of electrical charge to the dispensing device including closing the switch.

44. Apparatus for coating articles, the apparatus including means for dispensing coating material onto the articles, means for supplying electrical charge to the coating material as it is being dispensed, means for coupling the electrical charge supply means to the means for dispensing coating material, a first reservoir for containing a first coating material to be dispensed onto a first one of the articles as the first article is presented for coating, the first reservoir consisting essentially of a disposable first resin or polymer bag for coupling to the dispensing device, means for coupling the disposable first resin or polymer bag containing the first coating material to the means for dispensing coating material, a second reservoir for containing a second coating material to be dispensed onto a second one of the articles, the second reservoir consisting essentially of a disposable second resin or polymer bag for coupling to the dispensing device, means for filling the disposable second resin or polymer bag with the second coating material to be dispensed onto the second one of the articles, means for flushing the first coating material from the dispensing device, and means for coupling the disposable second resin or polymer bag containing the second coating material to the dispensing device, the means for coupling the electrical charge supply means to the means for dispensing coating material interrupting the supply of electrical charge to the dispensing device after coating the first article with the first coating material and resuming the supply of electrical charge to the dispensing device as the second article is presented for coating.

45. The apparatus of claim 44 wherein the means for coupling the electrical charge supply means to the means for dispensing coating material includes a switch.

46. Apparatus for coating including a plurality of different disposable containers, at least one for containing each of a plurality of different types of coating material that is to be dispensed from a coating material dispenser, means for dispensing the different types of coating material, means for coupling a source of each different type of coating material through a respective valve means to the means for dispensing the different types of coating material, the means for dispensing the different types of coating material including means for sequentially coupling the means for dispensing the different types of coating material to the plurality of different disposable containers and actuating the respective valve means to introduce into each of the plurality of different disposable containers a respective type of coating material, each of the plurality of different disposable containers consisting essentially of a resin or polymer bag.

47. The apparatus of claim 46 further including means for sequentially coupling the plurality of different disposable containers to the means for dispensing the different types of coating material when it is desired to coat an article with the respective type of coating material contained in each respective one of the plurality of different disposable containers to supply that respective type of coating material to the means for dispensing the different types of coating material.

48. The apparatus of claim 47 further including means for supplying electrical charge to the coating material as it is being dispensed, and means for coupling the electrical charge supply means to the means for dispensing coating material.
